(19) United States
(12) Patent Application Publication
(10) Pub. No.: US 2012/0121892 A1
(43) Pub. Date: May 17, 2012

(54) MISSILE WITH AN OUTER CASING AND AN ABLATION LAYER APPLIED THERETO, MATRIX MATERIAL AND METHOD FOR PRODUCING A MISSILE

(75) Inventors: PETER GERD FISCH, UEBERLINGEN (DE); GERD ELSNER, OBERUHLDINGEN (DE); RAINER HEZEL, ENGEN (DE)

(73) Assignee: DIEHL BGT DEFENCE GMBH & CO. KG, UEBERLINGEN (DE)

(21) Appl. No.: 13/297,451

(22) Filed: Nov. 16, 2011

(30) Foreign Application Priority Data
Nov. 17, 2010 (DE) 10 2010 051 752.6

(51) Int. Cl. B32B 18/00; B05D 5/00; B05D 3/00; B05D 7/00

(52) U.S. Cl. 428/325; 427/372.2

(57) ABSTRACT

A missile includes an outer casing and an outer coating applied thereto in the form of an ablation layer which contains a matrix material intended to at least partially decompose during a flight. Hollow glass bodies are embedded in the matrix material in order to keep the missile reliably operational even after flying at a speed above 1000 m/s. A matrix material and a method for producing a missile are also provided.

### CROSS-REFERENCE TO RELATED APPLICATION

This application claims the priority, under 35 U.S.C. §119, of German Patent Application DE 10 2010 051 752.6, filed Nov. 17, 2010; the prior application is herewith incorporated by reference in its entirety.

### BACKGROUND OF THE INVENTION

### Field of the Invention

The invention relates to a missile with an outer casing and an outer coating applied thereto in the form of an ablation layer, which contains a matrix material intended to at least partially decompose during a flight. The invention also relates to a matrix material for a missile and a method for producing a missile.

High-speed missiles that have maneuverability superior to their target, because of their high speed, are required for combating airborne targets. Flying speeds in excess of 1000 m/s are desirable in that case.

### SUMMARY OF THE INVENTION

It is accordingly an object of the invention to provide a missile with an outer casing and an ablation layer applied thereto, a matrix material and a method for producing a missile, which overcome the hereinafore-mentioned disadvantages of the heretofore-known missiles, materials and methods of this general type and which provide a missile that is reliably operational even after flying at a speed above 1000 m/s.

With the foregoing and other objects in view there is provided, in accordance with the invention, a missile, comprising an outer casing and an outer coating in the form of an ablation layer applied to the outer casing. A matrix material disposed in the ablation layer is intended to at least partially decompose during a flight. Hollow glass bodies are embedded in the matrix material.

The invention is based on the concept that, when flying at high speed in the atmosphere, frictional heat is produced and heats up a missile, in particular at its tip and tail assembly. That phenomenon is known from space travel in which, for example, gliding spacecraft are provided with a heat shield. The thermal insulating effect of such a heat shield is mainly achieved by a cooling boundary layer produced by pyrolysis between the missile or spacecraft and the atmospheric air passing by. The material of the heat shield gasifies and thereby forms a layer of gas around the heat shield that serves as a cooling boundary layer.

Such a heat shield is usually made of material in sheet form and is placed onto the missile and joined to it. With respect to missiles in the form of defence rockets, that procedure has the disadvantage that the application is complicated and consequently expensive, and the heat shield has a relatively great thickness to allow it to be placed on as a layer.

In contrast to spacecraft, the high velocity phase of a missile constructed as an unmanned guided missile, in particular as an anti-aircraft rocket, lasts only a few seconds. The effect of heat is consequently less than, for example, in the case of a gliding spacecraft. However, the outer casing is thinner and sensitive electronic components lie closer to the outer casing than in the case of a gliding spacecraft. Therefore, a critical temperature is lower than in the case of a gliding spacecraft. The requirements for a heat shield with an ablation layer on an unmanned guided missile are therefore different to the extent that it only has to be resistant to a relatively low level of heat for a short time, but the thermal shielding within that time must be good enough to ensure that the temperature of the outer casing lying thereunder rises only slightly, for example by less than 50 K, in particular less than 30 K.

The presence of hollow glass bodies in the matrix material of the ablation layer allows a high thermal insulation to be achieved even in the case of a very thin ablation layer, for example in the form of a layer of paint, so that the missile can be provided with a very thin ablation layer that nevertheless achieves a sufficient thermal insulating effect. The thickness of the ablation layer expediently lies below 1 mm, preferably below 0.7 mm, in particular below 0.5 mm. This allows the weight of the missile to be kept low and its range to be kept high.

The missile is expediently an unmanned guided missile, in particular with a rocket engine, for example a rocket intended for destroying targets with a mechanism causing the destruction. Such a rocket may be a surface-to-air rocket or an air-to-air rocket, that is to say a rocket for combating airborne targets. The outer casing of the missile may be a casing made of metal, which protects the internal components of the missile.

An ablation layer is distinguished by the fact that it is thermally decomposed at a flying speed at which the missile is intended to fly in regular operation. Thermal decomposition may be understood hereinafter as meaning that material of the ablation layer goes over at least partially from a solid state into a gaseous state when there is an increase in temperature. The ablation layer expediently loses at least 1% of its weight per minute, in particular per second, during thermal decomposition, with material going over from the solid state into the gaseous state. The amount of material specified above advantageously relates only to the matrix material of the ablation layer. An outer coating is understood as meaning such a coating that faces radially outwards. An interior coating, which faces an interior space, is not an outer coating in this sense.

The hollow glass bodies are expediently hollow glass beads. They are at least substantially spherical glass bodies which form a cavity inside them. The sphericity is achieved when the smallest outside diameter in any direction is not less than 50%, in particular 80%, of the greatest outside diameter of the hollow glass bead in another direction. The cavity is expediently filled with gas, preferably to at least 90%, in particular completely.

In accordance with another advantageous embodiment of the invention, at least 80% of the hollow glass bodies contained in the matrix material have an outside diameter of 12 μm±5 μm. This allows a good thermal insulating effect to be achieved even with a thin ablation layer of less than 1 mm in thickness. An average outside diameter of the hollow glass body, for example of a not quite spherical hollow glass bead, may be regarded in this case as the outside diameter.

In accordance with a further advantageous embodiment of the invention, the hollow glass bodies make up at least 20% of the volume of the ablation layer. This allows a good thermal insulating effect of the ablation layer to be achieved. With the hollow glass bodies accounting for up to 65% of the volume, the ablation layer can still remain mechanically stable enough that it does not partially peel off, even when subjected to reasonable impact.

With the objects of the invention in view, there is also provided a method for producing a missile with an outer casing. An outer coating in the form of an ablation layer, which contains a matrix material intended to at least partially decompose during a flight, is applied to the outer casing. According to the invention, it is proposed that hollow glass beads are embedded in the matrix material.

A thin ablation layer can be applied particularly easily in the form of a coat which is, for example, applied by a brush or sprayed onto the outer casing through a nozzle. Generally speaking, it is advantageous if the ablation layer is applied to the outer casing as a liquid material. A liquid material is understood to this extent as also meaning a viscous material that can be applied as a layer to the outer casing by spraying on or brushing. The initially liquid material is expediently of such a form that, after being applied to the outer casing, it is able to cure, and in particular cures automatically. The curing may take place by drying, by vulcanizing, by a chemical reaction of two different components or by some other way.

A matrix material is a material in which the hollow glass bodies can be embedded in such a way that they are firmly held in their position in the matrix material by the matrix material. Particularly advantageously, the matrix material is a paint.

The matrix material is expediently a self-curing material. The curing may take place by the evaporation of a thinner, by vulcanization or as a chemical reaction, for example in a multicomponent system.

Particularly advantageously, the matrix material contains an epoxy resin, whereby simple application and automatic curing can be achieved. An epoxy resin may be formed of polymers which, when a suitable hardener is added, cure from a liquid state into a solid state and form a thermoset material.

Also advantageously, the matrix material contains a polyester resin, with which simple application and automatic curing can likewise be achieved.

It is also possible and advantageous if the matrix material contains an elastomer. A terpolymer elastomer, such as for example EPDM (ethylene-propylene-diene rubber) is particularly suitable.

A likewise suitable ablation layer may be achieved by the matrix material containing a thermoplastic material, with PEEK (polyether ether ketone) being particularly suitable by virtue of its hardness and resistance.

Isocyanates, for example polyurethanes, which however are expediently not used as a foam but as a paint, are also suitable.

The chemical composition of the matrix material is advantageously chosen in such a way that the decomposing temperature of the matrix material lies between 150° C. and 250° C., in particular between 180° C. and 220° C. It is also advantageous if the composition including the matrix material and the hollow glass bodies is chosen in such a way that the thickness of the ablation layer is reduced by between 50 μm and 500 μm, in particular between 50 μm and 200 μm, when energy of 1 MW/m² is introduced within 20 s. This introduction of energy is typical at speeds of defence rockets in layers of air at low altitudes, so that within a typical flight of a defence rocket the corresponding layer thickness is given off by gasification and the protective thermal layer consequently forms.

A good protective thermal effect can also be achieved if, at a temperature of 200° C., the ablation layer loses 50 μm to 150 μm of its thickness within 20 seconds.

The ablation layer does not have to be the only layer on the outer casing of the missile and may be applied to a layer lying thereunder and/or with a layer lying thereover. It is even conceivable for there to be a number of layers lying thereunder and/or thereover. Good mechanical resistance of the ablation layer can be achieved if it includes a base layer and a top layer applied thereto, which is free from hollow glass bodies. The thermal insulating effect of the hollow glass bodies in the base layer with the hollow glass bodies causes a delay in the transfer of heat from the top layer into the outer casing of the missile.

The mechanically stable top layer can protect the base layer lying thereunder and is expediently formed in such a way that it likewise acts as an ablation layer, analogous to the base layer. In a high-speed flight of the missile, the top layer decomposes first and then the base layer, with both layers cooling the outer casing by the ablation effect. The top layer may be a layer of paint, and it is, in particular, thinner than the base layer, for example with a thickness not exceeding 300 μm.

It is also advantageous if the material of the top layer is kept at least largely the same as the matrix material of the base layer, so that both layers have at least substantially the same ablation effect, and consequently the same cooling effect.

A particularly stable layer on the outer casing can be achieved if the ablation layer is applied to a priming layer, which for its part is applied to the outer casing. The priming layer is expediently formed from the same material as the matrix material of the ablation layer. If the ablation layer is coated with a further layer, which is free from hollow glass bodies, an aerodynamically advantageous surface can be produced. Such a top layer may also be understood as a constituent part of the ablation layer, since the top layer is expediently likewise an ablation layer.

With the objects of the invention in view, there is concomitantly provided a matrix material, comprising embedded hollow glass bodies. According to the invention, it is proposed that the matrix material be used as an ablation layer intended to be at least partially vaporized during a flight and forming an outer coating on the outer casing of a missile.

Other features which are considered as characteristic for the invention are set forth in the appended claims.

Although the invention is illustrated and described herein as embodied in a missile with an outer casing and an ablation layer applied thereto, a matrix material and a method for producing a missile, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Further advantages are obtained from the following description of the drawings. In the drawings, exemplary embodiments of the invention are represented. The drawings and the description contain numerous features in combination, which a person skilled in the art will expediently also consider individually and put together into other meaningful combinations.

### BRIEF DESCRIPTION OF THE SEVERAL VIEWS OF THE DRAWING

FIG. 1 is a diagrammaric, top-plan view of a missile with an outer casing and fins, to which an ablation layer has been applied; and

FIG. 2 is an enlarged, longitudinal-sectional view through a tip of the missile of FIG. 1.

### DETAILED DESCRIPTION OF THE INVENTION

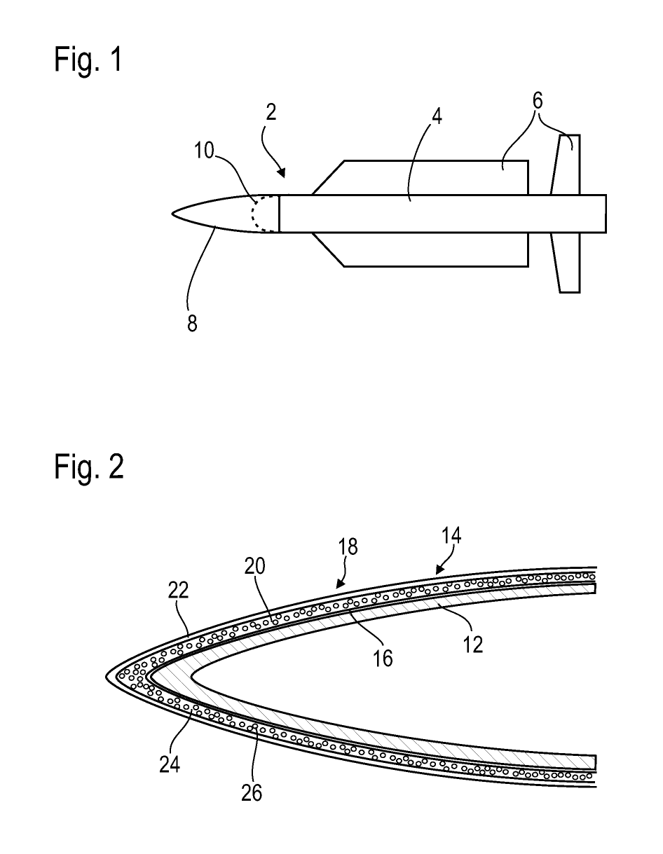

Referring now to the figures of the drawings in detail and first, particularly, to FIG. 1 thereof, there is seen a diagrammatic representation of a missile 2 with a body 4 bearing fins 6 and a shroud 8 which forms a tip of the missile 2 and protects a dome 10 disposed under the shroud 8. The missile 2 is an unmanned guided missile in the form of an anti-aircraft rocket for combating airborne targets and has a non-illustrated mechanism intended for explosively destroying the airborne target.

The body 4 and the shroud 8 form an outer casing of the missile 2 and it is optionally possible for the fins 6 to also be referred to as parts of the outer casing. A number of layers, which are represented in FIG. 2, have been applied to the outer casing, for example in the form of painting.

FIG. 2 shows a section through the tip of the missile 2. An outer casing 12 made of metal and a coating 14 applied thereto are shown. The coating 14 has also been applied to the fins 6. The coating 14 is made up of two layers 16, 18, with the layer 16 being a priming layer on the metal outer casing 12. The layer 18 has been applied to this priming as an outer coating, which therefore faces radially outwards when viewed from the outer casing 12 and is formed as an ablation layer. This ablation layer 18 includes a base layer 20 and a top layer 22 applied thereto.

The base layer 20 of the ablation layer 18 is formed from a matrix material 24 with hollow glass bodies 26 embedded therein. The layers 16 and 18 and the hollow glass bodies 26 are not shown to scale, but instead as overly thick or overly large. The matrix material 24 is a self-curing material in the form of an epoxy resin or a polyester resin, in which the hollow glass bodies 26 are firmly and immovably embedded after the curing of the matrix material 24. In a first exemplary embodiment, the top layer 22 is formed of the same material as the matrix material 24 and has been applied to the base layer 20 in the form of a covering layer of paint. The top layer 22 is free from hollow glass bodies 26. The priming layer 16 is formed of a different material than the matrix material 24.

While the priming layer 16 is approximately 200 μm thick, the ablation layer 18 is approximately 700 μm thick, the base layer 20 accounts for approximately 500 μm and the top layer 22 accounts for approximately 200 μm.

The hollow glass bodies 26 are hollow glass beads with an average outer radius of 12 μm. 90% of the hollow glass bodies 26 have an outside diameter of 12 μm±3 μm. The hollow glass bodies 26 make up approximately 25% by volume of the base layer 20.

In a further exemplary embodiment, the priming layer 16 is formed of the same material as the matrix material 24 of the base layer 20, whereas the top layer 22 is formed of a different material, for example a different paint, to reduce the surface roughness that is brought about by the base layer 20 bearing the hollow glass bodies 26. Thus, the priming layer 16 is formed, for example, of a layer of paint known as Seevenax® as an adhesion-promoting layer. A number of layers of Seevenax® with 25% by volume hollow glass bodies 26 have been applied to the priming layer 16 as the base layer 20, until a layer thickness of 500 μm is achieved. A top coat of paint, for example Alexit® Noridur® 406, is used as the top layer 22.

In order to produce the ablation layer 18, the matrix material 26 may be mixed with a thinner, into which the hollow glass bodies 26 have previously been introduced. For this purpose, the thinner may first be stirred with the hollow glass bodies 26 and then stirred together with the matrix material 24. For example, 1250 g of Seevenax, 250 g of hardener and 300 g of thinner are possible and advantageous, with 50 g of hollow glass bodies 26 having been stirred into 400 g of thinner.

A viscous mixture of not yet cured matrix material 24 and hollow glass bodies 26, also referred to as a liquid mixture, may be applied to the priming layer 16 through the use of a spray-painting device, to be precise in a number of layers, with one layer first curing before a further layer is applied. After curing of the uppermost layer of the base layer 20, the top layer 22 may subsequently be applied, likewise by the spray application device, and cured.

The base layer 20 obtained in this way has a decomposing temperature of approximately 200° C. and is reduced by approximately 70 μm when energy of 1 MW/m² is introduced within 20 s. In this way, it forms sufficient protection from heat, so that the outer casing 12 is not heated up by any more than 30° C. when this energy is introduced within 20 s.

The ablation layer 18 may also be applied without a top layer 22 and expediently covers at least the front part of the outer casing 12 of the missile 2, for example the outer casing 12 over a length of at least 10% of the overall missile 2. The ablation layer 18 expediently covers the entire body 4 as an outer coating, with it also being possible for the fins to be coated by the ablation layer.

1. A missile, comprising:
an outer casing;
an outer coating in the form of an ablation layer applied to said outer casing;
a matrix material disposed in said ablation layer and intended to at least partially decompose during a flight; and
hollow glass bodies embedded in said matrix material.

2. The missile according to claim 1, wherein at least 80% of said hollow glass bodies disposed in said matrix material have an outside diameter of 12 μm±5 μm.

3. The missile according to claim 1, wherein said hollow glass bodies make up at least 20% of the volume of said ablation layer.

4. The missile according to claim 1, wherein said matrix material is a self-curing material.

5. The missile according to claim 1, wherein said matrix material contains an epoxy resin.

6. The missile according to claim 1, wherein said matrix material contains a polyester resin.

7. The missile according to claim 1, wherein said matrix material contains an elastomer.

8. The missile according to claim 7, wherein said elastomer is a terpolymer elastomer.

9. The missile according to claim 1, wherein said matrix material contains a thermoplastic material.

10. The missile according to claim 1, wherein said matrix material contains an isocyanate.

11. The missile according to claim 1, wherein said ablation layer has a decomposing temperature of between 150° C. and 250° C.

12. The missile according to claim 1, wherein said matrix material and said hollow glass bodies form a composition causing a thickness of said ablation layer to be reduced by between 50 μm and 200 μm when energy of 1 MW/m² is introduced within 20 seconds.

13. The missile according to claim 1, wherein said ablation layer includes a base layer and a top layer applied to said base layer, said top layer being free of said hollow glass bodies.

14. The missile according to claim 13, wherein said top layer is formed of a material being the same as said matrix material.

15. A matrix material, comprising:
hollow glass bodies embedded as an ablation layer intended to be partially vaporized during a flight and forming an outer coating on an outer casing of a missile.

16. A method for producing a missile, the method comprising the following steps:
providing an outer casing;
providing an outer coating in the form of an ablation layer containing a matrix material intended to at least partially decompose during a flight and hollow glass bodies embedded in the matrix material;
applying the ablation layer to the outer casing as a liquid material; and
subsequently curing the liquid material.
